(19) United States
(12) Patent Application Publication
(10) Pub. No.: US 2023/0246295 A1
(43) Pub. Date: Aug. 3, 2023

(54) COATED SEPARATORS FOR ELECTROCHEMICAL CELLS AND METHODS OF FORMING THE SAME

(71) Applicant: GM GLOBAL TECHNOLOGY OPERATIONS LLC, Detroit, MI (US)

(72) Inventors: Xingcheng XIAO, Troy, MI (US); Yifan ZHAO, Warren, MI (US); Biqiong WANG, Madison Heights, MI (US); Shuru CHEN, Troy, MI (US); Mei CAI, Bloomfield Hills, MI (US)

(73) Assignee: GM GLOBAL TECHNOLOGY OPERATIONS LLC, Detroit, MI (US)

(21) Appl. No.: 17/588,707

(22) Filed: Jan. 31, 2022

(51) Int. Cl. H01M 50/434; H01M 50/449

(52) U.S. Cl. CPC H01M 50/434; H01M 50/449

(57) ABSTRACT

The present disclosure provides a coated separator including a porous separator and a ceramic coating disposed on one or more surfaces thereof. The ceramic coating includes a ceramic material and an additive selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof. In certain variations, the coated separator is prepared by contacting the porous separator with a slurry including the ceramic material and the additive. In other variations, the coated separator is prepared by forming a ceramic coating on one or more surfaces of a porous separator and contacting the porous separator with the additive, for example by immersing, or alternatively, a spraying process.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Many different materials may be used to create components for a lithium-ion battery. By way of non-limiting example, cathode materials for lithium-ion batteries typically comprise an electroactive material which can be intercalated or alloyed with lithium ions, such as lithium-transition metal oxides or mixed oxides of the spinel type, for example including spinel LiMn₂O₄, LiCoO₂, LiNiO₂, LiMn_{1.5}Ni_{0.5}O₄, LiNi_{(1-x-y)}CoₓM_{y}O₂(where 0<x<1, y<1, and M may be Al, Mn, or the like), or lithium iron phosphates. The electrolyte typically contains one or more lithium salts, which may be dissolved and ionized in a non-aqueous solvent. Common negative electrode materials include lithium insertion materials or alloy host materials, like carbon-based materials, such as lithium-graphite intercalation compounds, or lithium-silicon compounds, lithium-tin alloys, and lithium titanate Li₄₊ₓTi₅O₁₂, where 0≤x≤3, such as Li₄Ti₅O₁₂ (LTO).

The negative electrode may also be made of a lithium-containing material, such as metallic lithium, so that the electrochemical cell is considered a lithium metal battery or cell. Metallic lithium for use in the negative electrode of a rechargeable battery has various potential advantages, including having the highest theoretical capacity and lowest electrochemical potential. Thus, batteries incorporating lithium metal anodes can have a higher energy density that can potentially double storage capacity, so that the battery may be half the size, but still last the same amount of time as other lithium-ion batteries. Thus, lithium metal batteries are one of the most promising candidates for high energy storage systems. However, lithium metal batteries also have potential downsides, including possibly exhibiting unreliable or diminished performance and potential premature electrochemical cell failure. For example, side reactions may occur between the lithium metal and the adjacent electrolyte undesirably promoting the formation of a solid-electrolyte interface (“SEI”) and/or continuous electrolyte decomposition and/or active lithium consumption. Accordingly, it would be desirable to develop materials for use in high energy lithium-ion batteries that reduce or suppress lithium metal side reactions.

### SUMMARY

This section provides a general summary of the disclosure, and is not a comprehensive disclosure of its full scope or all of its features.

The present disclosure relates to separators for use in electrochemical cells, and more particularly, to coated separator and electrochemical cells including lithium metal electrodes, and methods of making and using the same.

In various aspects, the present disclosure provides a coated separator for use in an electrochemical cell that cycles lithium ions. The coated separator may include a porous separator and a ceramic coating disposed on the porous separator. The ceramic coating may include a ceramic material and an additive. The additive may be selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof. A mass loading of the additive in the ceramic coating may be greater than or equal to about 0.1 mg/cm² to less than or equal to about 10 mg/cm².

In one aspect, the ceramic material may be selected from the group consisting of: lithiated zeolite, zeolite, aerogel, silica, alumina, titania, metal-organic frameworks (MOFs), and combinations thereof.

In one aspect, the ceramic coating may have a thickness greater than or equal to about 1 μm to less than or equal to about 10 μm.

In one aspect, the ceramic coating may be a first ceramic coating, and the ceramic material may be a first ceramic material. The first ceramic coating may be disposed on a first surface of the porous separator, and the coated separator may further include a second ceramic coating disposed on a second surface of the porous separator, where the first surface is substantially parallel with the second surface. The second ceramic coating may include a second ceramic material selected from the group consisting of: lithiated zeolite, zeolite, aerogel, silica, alumina, titania, metal-organic frameworks (MOFs), and combinations thereof and a second additive selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof.

In one aspect, the ceramic coating may have a porosity greater than or equal to about 10 vol. % to less than or equal to about 80 vol. %.

In one aspect, the ceramic coating may be formed from a precursor coating having a porosity greater than or equal to about 20 vol. % to less than or equal to about 80 vol. %, where the additive at least partially impregnates pores of the precursor coating to form the ceramic coating.

In one aspect, the additive may include lithium nitrate (LiNO₃).

In various aspects, the present disclosure provides a method for forming a coated separator for use in an electrochemical cell that cycles lithium ions. The method may include contacting one or more surfaces of a microporous polymeric separator with a slurry including a ceramic material and at least one additive to form the coated separator. The at least one additive may be selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof.

In one aspect, the method may further include preparing the slurry. The slurry may include greater than or equal to about 20 wt. % to less than or equal to about 80 wt. % of the ceramic material, and greater than or equal to about 20 wt. % to less than or equal to about 80 wt. % of the at least one additive.

In one aspect, the ceramic material may be selected from the group consisting of: lithiated zeolite, zeolite, aerogel, silica, alumina, titania, metal-organic frameworks (MOFs), and combinations thereof.

In various aspects, the present disclosure may provide a method for forming a coated separator for use in an electrochemical cell that cycles lithium ions. The method may include contacting one or more additives and a precursor separator. The precursor separator may include a microporous polymeric separator and one or more ceramic coatings disposed on or near one or more surfaces of the microporous polymeric separator. The one or more additives may be selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof. The one or more additives may impregnate the one or more ceramic coatings to form the coated separator.

In one aspect, the contacting may include immersing the precursor separator in a solution that includes the one or more additives for a period greater than or equal to about 1 minute to less than or equal to about 5 hours.

In one aspect, the solution may include a solvent having a first wettability with the one or more ceramic coatings and a second wettability with the microporous polymeric separator, where the first wettability is greater than the second wettability.

In one aspect, the method may further include at least one of: (i) preparing the solution; (ii) coating the one or more surfaces of the microporous polymeric separator with the one or more ceramic coatings; and (iii) drying the one or more ceramic coatings after contacting the solution.

In one aspect, the drying may include a vacuum drying process having a temperature greater than or equal to about 50° C. to less than or equal to about 130° C. and a period greater than or equal to about 1 hour to less than or equal to about 24 hours.

In one aspect, the contacting may include spraying an aerosol spray that includes the one or more additives onto the one or more ceramic coatings. The aerosol spray may include a solvent having a first wettability with the one or more ceramic coating and a second wettability with the microporous polymeric separator, where the first wettability is greater than the second wettability. The aerosol spray may have a viscosity less than or equal to about 1,000 cp at room temperature.

In one aspect, the method may further include at least one of: (i) preparing the aerosol spray; and (ii) drying the one or more ceramic coatings after contacting the aerosol spray.

In one aspect, the drying may include a vacuum drying process having a temperature greater than or equal to about 50° C. to less than or equal to about 130° C. and a period of greater than or equal to about 1 hour to less than or equal to about 24 hours.

In one aspect, the one or more ceramic coatings may each include a ceramic material independently selected from the group consisting of: lithiated zeolite, zeolite, aerogel, silica, alumina, titania, metal-organic frameworks (MOFs), and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical battery cell including a coated separator in accordance with various aspects of the present disclosure;

FIG. 2 is a flowchart illustrating an example method for forming a coated separator, for use in an electrochemical battery cell, in accordance with various aspects of the present disclosure;

FIG. 3 is a flowchart illustrating another example method for forming a coated separator, for use in an electrochemical battery cell, in accordance with various aspects of the present disclosure;

FIG. 4 is a flowchart illustrating another example method for forming a coated separator, for use in an electrochemical battery cell, in accordance with various aspects of the present disclosure;

FIG. 5A is a graphical illustration demonstrating the discharge capacity of an example battery cell including a coated separator in accordance with various aspects of the present disclosure;

FIG. 5B is a graphical illustration demonstrating the capacity retention of an example battery cell including a coated separator in accordance with various aspects of the present disclosure;

FIG. 6 is a graphical illustration demonstrating electrochemical impedance of an example battery cell including a coated separator in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

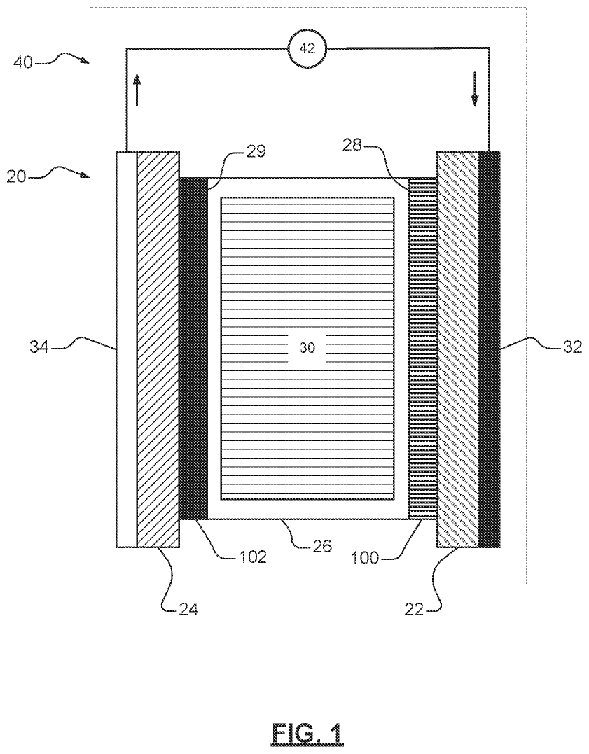

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 may be a metal foil, metal grid or screen, or expanded metal comprising copper or any other appropriate electrically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electrically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may be a microporous polymeric separator having a porosity greater than or equal to about 20 vol. % to less than or equal to about 80 vol. %, and in certain aspects, optionally greater than or equal to about 40 vol. % to less than or equal to about 60 vol. %. The porous separator 26 may be a microporous polymeric separator having a porosity greater than or equal to 20 vol. % to less than or equal to 80 vol. %, and in certain aspects, optionally greater than or equal to 40 vol. % to less than or equal to 60 vol. %.

In certain variations, the porous separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP). Commercially available polyolefin porous separator membranes 26 include, for example, CELGARD® 2500 (which is a monolayer polypropylene separator) and CELGARD® 2320 (which is a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymeric separator. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm. The separator 26 may have an average thickness greater than or equal to 1 μm to less than or equal to 50 μm, and in certain instances, optionally greater than or equal to 1 μm to less than or equal to 20 μm.

In each variation, the separator 26 may further include one or more ceramic materials and/or one or more heat-resistant materials. For example, the separator 26 may also be admixed with the one or more ceramic materials and/or the one or more heat-resistant materials, or one or more surfaces of the separator 26 may be coated with the ceramic material and/or the heat-resistant material. For example, as illustrated, a first ceramic coating 100 may be disposed between the separator 26 and the negative electrode 22, and a second ceramic coating 102 may be disposed between the separator 26 and the positive electrode 24. That is, the first ceramic coating 100 may be disposed on or adjacent to a first surface 28 of the separator 26, and the second ceramic coating 102 may be disposed on or adjacent to a second surface 29 of the separator 26. Although first and second ceramic coatings 100, 102 are illustrated in FIG. 1, the skilled artisan will recognize that in various aspects, the battery 20 may include only one of the first and second ceramic coatings 100, 102.

In various aspects, the first and second ceramic coatings 100, 102 have porosities greater than or equal to about 20 vol. % to less than or equal to about 80 vol. %, and in certain aspects, optionally greater than or equal to about 40 vol. % to less than or equal to about 60 vol. %. The first and second ceramic coatings 100, 102 have porosities greater than or equal to 20 vol. % to less than or equal to 80 vol. %, and in certain aspects, optionally greater than or equal to 40 vol. % to less than or equal to 60 vol. %.

The first and second ceramic coatings 100, 102 may be the same or different. For example, the first and second ceramic coatings 100, 102 may each include one or more ceramic materials independently selected from the group consisting of: lithiated zeolite, zeolite, aerogel, silica, alumina, titania, metal-organic frameworks (MOFs), and combinations thereof. The quantity of polar functional groups including, for example, Si—O and/or Al—O, in the first and second ceramic coatings 100, 102 help to facilitate the uniform distribution of lithium ion (Li⁺) on lithium plating surfaces (i.e., one or more surfaces of the negative electrode current collector 32 and/or one or more surfaces of the negative electrode 22), thereby suppressing or reducing lithium dendrite growth during battery operation.

In various aspects, at least one of the first and second ceramic coatings 100, 102 further includes one or more additives. For example, at least one of the first and second ceramic coatings 100, 102 may have a mass loading of the one or more additives that is greater than or equal to about 0.1 mg/cm² to less than or equal to about 10 mg/cm². The one or more additives may be selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof. The lithium halide salts may include, for example only, rubidium fluoride (RbF), cesium fluoride (CsF), potassium fluoride (KF), and the like.

In certain variations, the one or more ceramic materials defining the first ceramic coating 100 and/or the second ceramic coating 102 may be impregnated with the one or more additives. For example, the one or more additives may be disposed in the pores of the one or more ceramic materials defining the first ceramic coating 100 and/or the second ceramic coating 102, such that the at least one of the first and second ceramic coatings 100, 102 including the one or more additives has a porosity greater than or equal to about 10 vol. % to less than or equal to about 80 vol. %, and in certain aspects, optionally greater than or equal to about 30 vol. % to less than or equal to about 60 vol. %. The first and second ceramic coatings 100, 102 including the one or more additives may have a porosity greater than or equal to 10 vol. % to less than or equal to 80 vol. %, and in certain aspects, optionally greater than or equal to 30 vol. % to less than or equal to 60 vol. %.

The one or more additives often have reduced solubility (e.g., about 10⁻⁵ g/mL) in carbonate-based electrolytes, which causes the additive(s) to be consumed quickly during solid-electrolyte interphase (“SEI”) layer formation. Incorporating the one or more additives in the first ceramic coating 100 and/or the second ceramic coating 102 ensures that the one or more additives (e.g., lithium nitrate (LiNO₃)) are gradually slowly released into (e.g., dissolved in) the electrolyte 30 (e.g., carbonate-based electrolyte) during battery operation (for example, as a result of the low solubility of the one or more additives in the electrolyte 30 and/or the consumption of the one or more additives during cycling), which provides longer term stabilization of any as-formed solid-electrolyte interphase (“SEI”) layer (not shown), as formed on, for example, one or more lithium plated surfaces (i.e., one or more surfaces of the negative electrode current collector 32 and/or one or more surfaces of the negative electrode 22). More specifically, the one or more additives may react with lithium to form byproducts that enhance the quality of any as-formed solid-electrolyte interphase (“SEI”) layer, thereby improving lithium plating/stripping efficiency and cell life and performance.

The first and second ceramic coatings 100, 102 may be substantially continuous coatings. In other variations, the first and second ceramic coatings 100, 102 may have independently selected patterns. In each variation, however, the first ceramic coating 100 may cover greater than or equal to about 70%, optionally greater than or equal to about 75%, optionally greater than or equal to about 80%, optionally greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of the first surface 28; and the second ceramic coating 102 may cover greater than or equal to about 70%, optionally greater than or equal to about 75%, optionally greater than or equal to about 80%, optionally greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of the second surface 29. The first ceramic coating 100 may cover greater than or equal to 70%, optionally greater than or equal to 75%, optionally greater than or equal to 80%, optionally greater than or equal to 85%, optionally greater than or equal to 90%, optionally greater than or equal to 95%, optionally greater than or equal to 98%, optionally greater than or equal to 99%, and in certain aspects, optionally greater than or equal to 99.5%, of the first surface 28; and the second ceramic coating 102 may cover greater than or equal to 70%, optionally greater than or equal to 75%, optionally greater than or equal to 80%, optionally greater than or equal to 85%, optionally greater than or equal to 90%, optionally greater than or equal to 95%, optionally greater than or equal to 98%, optionally greater than or equal to 99%, and in certain aspects, optionally greater than or equal to 99.5%, of the second surface 29. In each variation, the first and second ceramic coatings 100, 102 may each have an average thickness greater than or equal to about 1 μm to less than or equal to about 10 μm, and in certain aspects, optionally greater than or equal to 1 μm to less than or equal to 10 μm.

The positive electrode 24 may be formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. In certain variations, the positive electrode 24 may include a plurality of solid-state electrolyte particles (not shown). In each instance, the positive electrode 24 may have an average thickness greater than or equal to about 1 μm to less than or equal to about 500 μm, and in certain aspects, optionally greater than or equal to about 10 μm to less than or equal to about 200 μm. The positive electrode 24 may have an average thickness greater than or equal to 1 μm to less than or equal to 500 μm, and in certain aspects, optionally greater than or equal to 10 μm to less than or equal to 200 μm.

One exemplary common class of known materials that can be used to form the positive electrode 24 is layered lithium transitional metal oxides. For example, in certain aspects, the positive electrode 24 may comprise one or more materials having a spinel structure, such as lithium manganese oxide (Li₍₁₊ₓ₎Mn₂O₄, where 0.1≤x≤1) (LMO), lithium manganese nickel oxide (LiMn₍₂₋ₓ₎NiₓO₄, where 0≤x≤0.5) (LNMO) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.33}O₂) (NMC), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄) (LFP), lithium manganese-iron phosphate (LiMn₂-xFexPO₄, where 0<x<0.3) (LFMP), or lithium iron fluorophosphate (Li₂FePO₄F). In various aspects, the positive electrode 24 may comprise one or more electroactive materials selected from the group consisting of: NCM 111, NCM 532, NCM 622, NCM 811, NCMA, LFP, LMO, LFMP, LLC, and combinations thereof.

In certain variations, the positive electroactive material(s) in the positive electrode 24 may be optionally intermingled with an electronically conducting material that provides an electron conduction path and/or at least one polymeric binder material that improves the structural integrity of the electrode 24. For example, the positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The positive electrode 24 may include greater than or equal to about 5 wt. % to less than or equal to about 99 wt. %, optionally greater than or equal to about 10 wt. % to less than or equal to about 99 wt. %, and in certain variations, greater than or equal to about 50 wt. % to less than or equal to about 98 wt. %, of the positive electroactive material(s); greater than or equal to 0 wt. % to less than or equal to about 40 wt. %, and in certain aspects, optionally greater than or equal to about 1 wt. % to less than or equal to about 20 wt. %, of the electronically conducting material; and greater than or equal to 0 wt. % to less than or equal to about 40 wt. %, and in certain aspects, optionally greater than or equal to about 1 wt. % to less than or equal to about 20 wt. %, of the at least one polymeric binder.

The positive electrode 24 may include greater than or equal to 5 wt. % to less than or equal to 99 wt. %, optionally greater than or equal to 10 wt. % to less than or equal to 99 wt. %, and in certain variations, greater than or equal to 50 wt. % to less than or equal to 98 wt. %, of the positive electroactive material(s); greater than or equal to 0 wt. % to less than or equal to 40 wt. %, and in certain aspects, optionally greater than or equal to 1 wt. % to less than or equal to 20 wt. %, of the electronically conducting material; and greater than or equal to 0 wt. % to less than or equal to 40 wt. %, and in certain aspects, optionally greater than or equal to 1 wt. % to less than or equal to 20 wt. %, of the at least one polymeric binder.

The negative electrode 22 may be formed from a lithium host material that is capable of functioning as a negative terminal of a lithium-ion battery. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, in certain variations, the negative electrode 22 may include a plurality of solid-state electrolyte particles (not shown). In each instance, the negative electrode 22 (including the one or more layers) may have a thickness greater than or equal to 0 nm to less than or equal to about 500 μm, optionally greater than or equal to about 1 μm to less than or equal to about 500 μm, and in certain aspects, optionally greater than or equal to about 10 μm to less than or equal to about 200 μm. The negative electrode 22 (including the one or more layers) may have a thickness greater than or equal to 0 nm μm to less than or equal to 500 μm, optionally greater than or equal to 1 μm to less than or equal to 500 μm, and in certain aspects, optionally greater than or equal to 10 μm to less than or equal to 200 μm.

In various aspects, the negative electroactive material may include lithium, for example, a lithium alloy and/or a lithium metal. For example, in certain variations, the negative electrode 22 may be defined by a lithium metal foil. In other variations, the negative electroactive material may include, for example only, carbonaceous materials (such as, graphite, hard carbon, soft carbon, and the like) and/or metallic active materials (such as tin, aluminum, magnesium, germanium, and alloys thereof, and the like). In still other variations, the negative electroactive material may be a silicon-based electroactive material, and in further variations, the negative electroactive material may include a combination of the silicon-based electroactive material (i.e., first negative electroactive material) and one or more other negative electroactive materials. The one or more other negative electroactive materials include, for example only, carbonaceous materials (such as, graphite, hard carbon, soft carbon, and the like) and metallic active materials (such as tin, aluminum, magnesium, germanium, and alloys thereof, and the like). For example, in certain variations, the negative electroactive material may include a carbonaceous-silicon based composite including, for example, about 10 wt. % of a silicon-based electroactive material and about 90 wt. % graphite. The negative electroactive material may include a carbonaceous-silicon based composite including, for example, 10 wt. % of a silicon-based electroactive material and 90 wt. % graphite.

In certain variations, the negative electroactive material(s) in the negative electrode 22 may be optionally intermingled with one or more electrically conductive materials that provide an electron conductive path and/or at least one polymeric binder material that improves the structural integrity of the negative electrode 22. For example, the negative electroactive material(s) in the negative electrode 22 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The negative electrode 22 may include greater than or equal to about 5 wt. % to less than or equal to about 99 wt. %, optionally greater than or equal to about 10 wt. % to less than or equal to about 99 wt. %, and in certain variations, greater than or equal to about 50 wt. % to less than or equal to about 95 wt. %, of the negative electroactive material(s); greater than or equal to 0 wt. % to less than or equal to about 40 wt. %, and in certain aspects, optionally greater than or equal to about 1 wt. % to less than or equal to about 20 wt. %, of the electronically conducting material; and greater than or equal to 0 wt. % to less than or equal to about 40 wt. %, and in certain aspects, optionally greater than or equal to about 1 wt. % to less than or equal to about 20 wt. %, of the at least one polymeric binder.

The negative electrode 22 may include greater than or equal to 5 wt. % to less than or equal to 99 wt. %, optionally greater than or equal to 10 wt. % to less than or equal to 99 wt. %, and in certain variations, greater than or equal to 50 wt. % to less than or equal to 95 wt. %, of the negative electroactive material(s); greater than or equal to 0 wt. % to less than or equal to 40 wt. %, and in certain aspects, optionally greater than or equal to 1 wt. % to less than or equal to 20 wt. %, of the electronically conducting material; and greater than or equal to 0 wt. % to less than or equal to 40 wt. %, and in certain aspects, optionally greater than or equal to 1 wt. % to less than or equal to 20 wt. %, of the at least one polymeric binder.

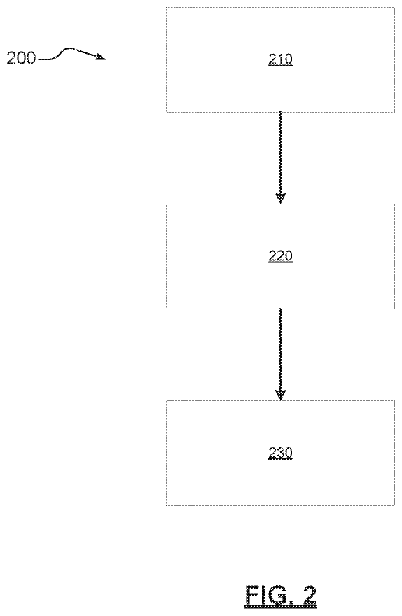

In various aspects, the present disclosure provides methods for forming separators to be in an electrochemical cell that cycles lithium ions (such as battery 20, as illustrated in FIG. 1), and more particularly, to forming coated separators to be used in an electrochemical cell that cycles lithium ions (such as battery 20, as illustrated in FIG. 1). For example, FIG. 2 sets forth an example method 200 for forming a coated separator for use in an electrochemical cell that cycles lithium ions (such as battery 20, as illustrated in FIG. 1). In various aspects, the method 200 includes contacting 240 a slurry with one or more surfaces of a separator, such that the slurry coats the one or more surfaces of the separator and forms the coated separator. In certain variations, contacting 220 may include a dry powder spray process. In certain variations, as illustrated, the method 200 may further include preparing 210 the slurry and/or drying 230 the slurry.

In each instance, the slurry includes, for example, one or more ceramic materials and one or more additives dispersed therewithin. For example, the slurry may include greater than or equal to about 20 wt. % to less than or equal to about 80 wt. % of the one or more ceramic materials, and greater than or equal to about 20 wt. % to less than or equal to about 80 wt. % of the one or more additives. The slurry may include greater than or equal to 20 wt. % to less than or equal to 80 wt. % of the one or more ceramic materials, and greater than or equal to 20 wt. % to less than or equal to 80 wt. % of the one or more additives.

The one or more ceramic materials may include, for example, lithiated zeolite, zeolite, aerogel, silica, alumina, titania, metal-organic frameworks (MOFs), and combinations thereof. The one or more additives may include, for example, lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts (e.g., rubidium fluoride (RbF), cesium fluoride (CsF), potassium fluoride (KF), and the like), and combinations thereof. In certain variations, the slurry may further include one or more solvents and one or more binders. When aqueous binders (e.g., carboxymethyl cellulose (CMC), styrene-butadiene rubber (SBR), and the like) are used, the solvent may be water. When non-aqueous binders are used (e.g., polyvinylidene difluoride (PVdF)), the solvent may be, for example, N-methylpyrrolidone (NMP).

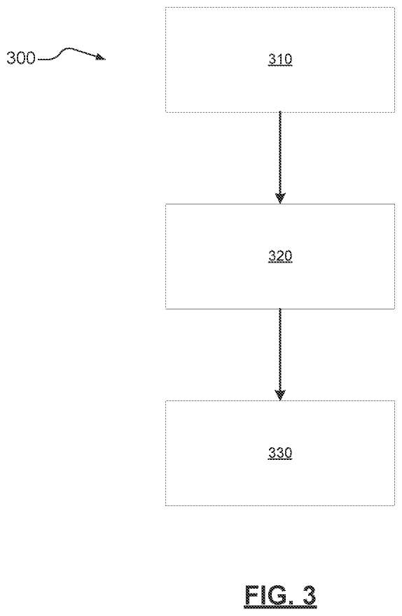

FIG. 3 illustrates another example method 300 for forming a coated separator for use in an electrochemical cell that cycles lithium ions (such as battery 20, as illustrated in FIG. 1). In various aspects, the method 300 includes preparing 310 one or more precursor coatings on one or more surfaces of a separator. The one or more precursor coatings may be ceramic coatings having porosities greater than or equal to about 20 vol. % to less than or equal to about 80 vol. %, and in certain aspects, optionally greater than or equal to about 40 vol. % to less than or equal to about 60 vol. %. The one or more precursor coatings may be ceramic coatings having porosities greater than or equal to 20 vol. % to less than or equal to 80 vol. %, and in certain aspects, optionally greater than or equal to 40 vol. % to less than or equal to 60 vol. %.

The one or more precursor coatings may each include one or more ceramic materials independently selected from the group consisting of: lithiated zeolite, zeolite, aerogel, silica, alumina, titania, metal-organic frameworks (MOFs), and combinations thereof. In certain variations, preparing 310 the one or more precursor coatings may include coating the one or more surfaces of the separator using, for example, dip coating and/or spray coating methods.

The method 300 may further include contacting 320 the separator including the one or more precursor coatings and a solution including one or more additives. In certain variations, contacting 320 may include immersing the separator including the one or more precursor coatings in the solution including the one or more additives. In each variation, the one or more additives may include, for example, lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts (e.g., rubidium fluoride (RbF), cesium fluoride (CsF), potassium fluoride (KF), and the like), and combinations thereof.

The solution may be an aqueous or non-aqueous solution that further comprises, for example, one or more solvents and one or more binders. When aqueous binders (e.g., carboxymethyl cellulose (CMC), styrene-butadiene rubber (SBR), and the like) are used, the solvent may be water. When non-aqueous binders are used (e.g., polyvinylidene difluoride (PVdF)), the solvent may be, for example, N-methylpyrrolidone (NMP). In each instance, the solvent is selected such that the solution has good wettability (e.g., contact angle less than or equal to about 60°) with regard to the one or more precursor coatings and poor wettability (e.g., contact angle greater than or equal to about 100°) with regard to the microporous polymeric separator, such that the solution impregnates (i.e., at least partially fills pores of) the one or more precursor coatings and not the micro microporous polymeric separator. In each variation, the separator including the one or more precursor coatings may be kept in contact with the solution including the one or more additives for a time greater than or equal to about 1 minute to less than or equal to about 5 hours, and in certain aspects, optionally greater than or equal to 1 minute to less than or equal to 5 hours.

The method 300 may further include drying 330 the separator including the one or more precursor coatings having the one or more additives impregnated therein. In certain variations, drying 330 may include vacuum drying the separator including the one or more precursor coatings and the one or more additives impregnated therein at a temperature greater than or equal to about 50° C. to less than or equal to about 130° C., and in certain aspects, optionally greater than or equal to 50° C. to less than or equal to 130° C., for a time greater than or equal to about 1 hour to less than or equal to about 24 hours, and in certain aspects, optionally greater than or equal to 1 hour to less than or equal to 24 hours.

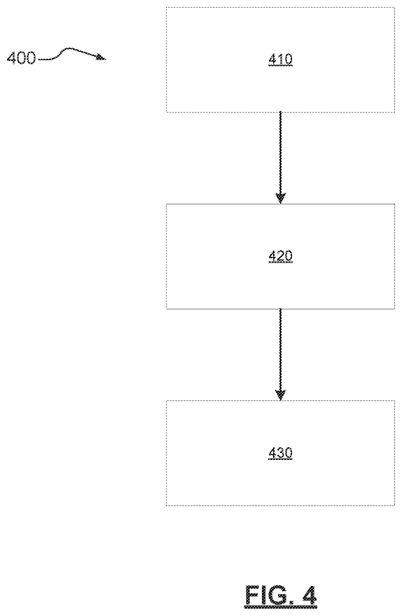

FIG. 4 illustrates another example method 400 for forming a coated separator for use in an electrochemical cell that cycles lithium ions (such as battery 20, as illustrated in FIG. 1). In various aspects, the method 400 includes preparing 410 one or more precursor coatings on one or more surfaces of a separator. The one or more precursor coatings may be ceramic coatings having porosities greater than or equal to about 20 vol. % to less than or equal to about 80 vol. %, and in certain aspects, optionally greater than or equal to about 40 vol. % to less than or equal to about 60 vol. %. The one or more precursor coatings may be ceramic coatings having porosities greater than or equal to 20 vol. % to less than or equal to 80 vol. %, and in certain aspects, optionally greater than or equal to 40 vol. % to less than or equal to 60 vol. %.

The one or more precursor coatings may each include one or more ceramic materials independently selected from the group consisting of: lithiated zeolite, zeolite, aerogel, silica, alumina, titania, metal-organic frameworks (MOFs), In certain variations, preparing 410 the one or more precursor coatings may include coating the one or more surfaces of the separator using, for example, dip coating and/or spray coating methods.

The method 400 may further include contacting 420 the separator including the one or more precursor coatings and a solution including one or more additives. In certain variations, contacting 420 may include forming an aerosol spray that includes the solution and spraying exposed surfaces of the one or more precursor coatings with the solution. The aerosol spray may have a viscosity less than or equal to about 1,000 cp at room temperature (e.g., between about 21° C. and about 22° C.). For example, the aerosol spray may have a viscosity greater than or equal to about 30 cp to less than or equal to about 1,000 cp, and in certain aspects, optionally greater than or equal to 30 cp to less than or equal to 1,000 cp, at room temperature. In certain variations, the separator may be in contact with (e.g., carried by) a substrate stage during the contacting 420. The substrate stage may be heated (e.g., less than or equal to about 50° C.) during the contacting 420 so to allow for faster drying of the aerosol spray.

In each variation, the one or more additives may include, for example, lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts (e.g., rubidium fluoride (RbF), cesium fluoride (CsF), potassium fluoride (KF), and the like), and combinations thereof. The solution may further include, for example, one or more solvents that readily vaporize. For example, the one or more solvents may be selected from the group consisting of: methanol, ethanol, bis(2-methoxyethyl) ether (diglyme or G2), dimethoxyethane (DME), dibutyl ether (DBE), dioxolane (DOL), and combinations thereof. The solvent is selected such that the solution has good wettability (e.g., contact angle less than or equal to about 60°) with regard to the one or more precursor coatings and poor wettability (e.g., contact angle greater than or equal to about 100°) with regard to the microporous polymeric separator, such that the solution impregnates (i.e., at least partially fills pores of) the one or more precursor coatings and not the micro microporous polymeric separator.

The method 400 may further include drying 430 the separator including the one or more precursor coatings having the one or more additives impregnated therein. In certain variations, drying 430 may include vacuum drying the separator including the one or more precursor coatings and the one or more additives impregnated therein at a temperature greater than or equal to about 50° C. to less than or equal to about 130° C., and in certain aspects, optionally greater than or equal to 50° C. to less than or equal to 130° C., for a time greater than or equal to about 1 hour to less than or equal to about 24 hours, and in certain aspects, optionally greater than or equal to 1 hour to less than or equal to 24 hours.

Certain features of the current technology are further illustrated in the following non-limiting examples.

### Example 1

Example battery cells may be prepared in accordance with various aspects of the present disclosure.

For example, an example battery cell 510 may include a coated separator in accordance with various aspects of the present disclosure. The example battery cell 510 may include a microporous polymeric separator (e.g., CELGARD® 2500) having a ceramic coating (e.g., lithiated zeolite) that includes one or more additives (e.g., lithium nitrate (LiNO₃)). A comparative battery cell 520 may include a non-coated microporous polymeric separator (e.g., CELGARD® 2500). A comparative battery cell 530 may include a microporous polymeric separator (e.g., CELGARD® 2500) having a ceramic coating (e.g., lithiated zeolite), but omitting the one or more additives (e.g., lithium nitrate (LiNO₃)). A comparative battery cell 540 may include a microporous polymeric separator (e.g., CELGARD® 2500) impregnated with the one or more additives (e.g., lithium nitrate (LiNO₃)).

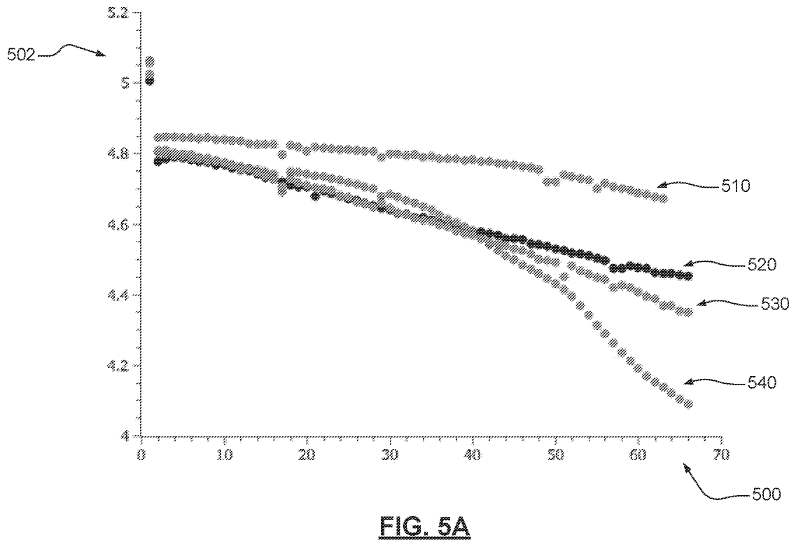

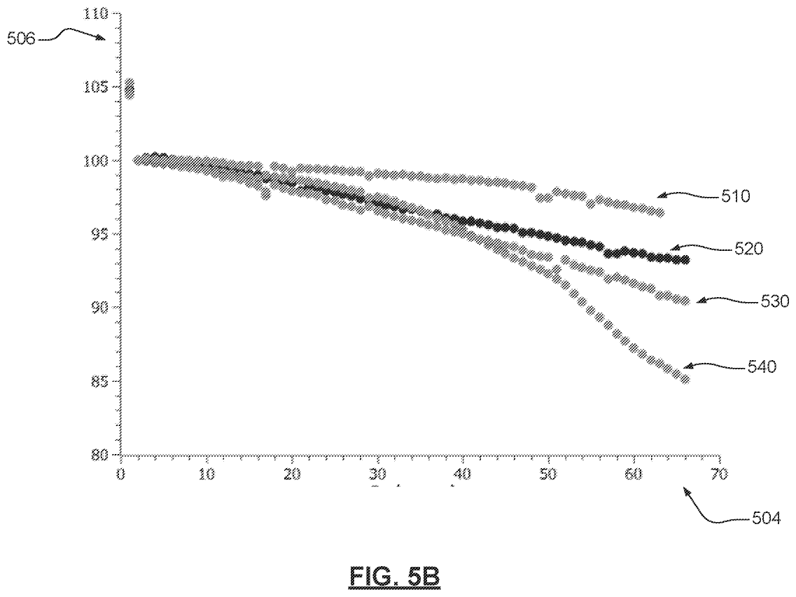

FIG. 5A is a graphical illustration demonstrating discharge capacity of the example battery cell 510 as compared to the comparative battery cells 520, 530, 540, where the x-axis 500 represents cycle number, and the y-axis 502 represents discharge capacity (mAh/cm²). As illustrated, the example battery cell 510 has improved cell performance, including both cell discharge capacity and cell cycle stability, which is evidenced by the flattening of the curve with high values, as a function of cycle number.

FIG. 5B is a graphical illustration demonstrating the capacity retention of the example battery cell 510 as compared to the comparative battery cells 520, 530, 540, where the x-axis 504 represents cycle number, and the y-axis 506 represents capacity retention (%). As illustrated, the example battery cell 510 has improved capacity retention over time. For example, the example battery cell 520, as illustrated, has about 30% cycle life improvement.

### Example 2

Example battery cells may be prepared in accordance with various aspects of the present disclosure.

For example, an example battery cell 610 may include a coated separator in accordance with various aspects of the present disclosure. The example battery cell 610 may include a microporous polymeric separator (e.g., CELGARD® 2500) having a ceramic coating (e.g., lithiated zeolite) that includes one or more additives (e.g., lithium nitrate (LiNO₃)). A comparative battery cell 620 may include a non-coated microporous polymeric separator (e.g., CELGARD® 2500). A comparative battery cell 630 may include a microporous polymeric separator (e.g., CELGARD® 2500) having a ceramic coating (e.g., lithiated zeolite), but omitting the one or more additives (e.g., lithium nitrate (LiNO₃)).

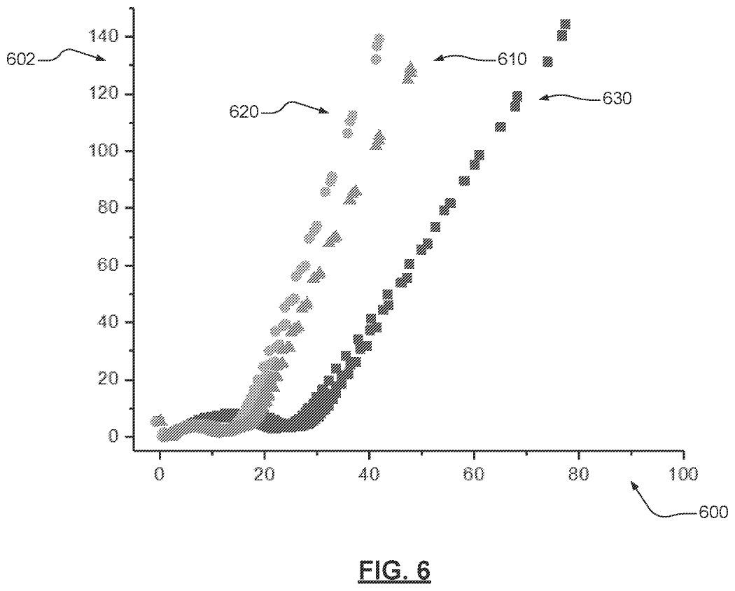

FIG. 6 is a graphical illustration demonstrating the electrical impedance of the example battery cell 610 as compared to the comparative battery cells 620 and 630, where the x-axis 600 represents Re(Z)/Ohm, and the y-axis 602 represents Im(Z)/Ohm. As illustrated, the example battery cell 610 has improved electrochemical impedance. For example, the example battery cell 610, as illustrated, has about 50% impedance reduction.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A coated separator for use in an electrochemical cell that cycles lithium ions, the coated separator comprising:
a porous separator; and
a ceramic coating disposed on the porous separator, the ceramic coating comprising a ceramic material and an additive selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof, wherein a mass loading of the additive in the ceramic coating is greater than or equal to about 0.1 mg/cm² to less than or equal to about 10 mg/cm².

2. The coated separator of claim 1, wherein the ceramic material is selected from the group consisting of: lithiated zeolite, zeolite, aerogel, silica, alumina, titania, metal-organic frameworks (MOFs), and combinations thereof.

3. The coated separator of claim 1, wherein the ceramic coating has a thickness greater than or equal to about 1 μm to less than or equal to about 10 μm.

4. The coated separator of claim 1, wherein the ceramic coating is a first ceramic coating, the ceramic material is a first ceramic material, the first ceramic coating is disposed on a first surface of the porous separator, and the coated separator further comprises a second ceramic coating disposed on a second surface of the porous separator, the first surface being substantially parallel with the second surface,
wherein the second ceramic coating comprises a second ceramic material selected from the group consisting of: lithiated zeolite, zeolite, aerogel, silica, alumina, titania, metal-organic frameworks (MOFs), and combinations thereof and a second additive selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof.

5. The coated separator of claim 1, wherein the ceramic coating has a porosity greater than or equal to about 10 vol. % to less than or equal to about 80 vol. %.

6. The coated separator of claim 1, wherein the ceramic coating is formed from a precursor coating having a porosity greater than or equal to about 20 vol. % to less than or equal to about 80 vol. %, wherein the additive at least partially impregnates pores of the precursor coating to form the ceramic coating.

7. The coated separator of claim 1, wherein the additive comprises lithium nitrate (LiNO₃).

9. A method for forming a coated separator for use in an electrochemical cell that cycles lithium ions, the method comprising:
contacting one or more surfaces of a microporous polymeric separator with a slurry that comprises a ceramic material and at least one additive to form the coated separator, wherein the at least one additive is selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof.

10. The method of claim 9, wherein the method further comprises:
preparing the slurry, wherein the slurry comprises greater than or equal to about 20 wt. % to less than or equal to about 80 wt. % of the ceramic material, and greater than or equal to about 20 wt. % to less than or equal to about 80 wt. % of the at least one additive.

11. The method of claim 9, wherein the ceramic material is selected from the group consisting of: lithiated zeolite, zeolite, aerogel, silica, alumina, titania, metal-organic frameworks (MOFs), and combinations thereof.

12. A method for forming a coated separator for use in an electrochemical cell that cycles lithium ions, the method comprising:
contacting one or more additives and a precursor separator, the precursor separator comprising a microporous polymeric separator and one or more ceramic coatings disposed on or near one or more surfaces of the microporous polymeric separator, wherein the one or more additives are selected from the group consisting of: lithium nitrate (LiNO₃), lithium phosphate (LiPO₃), lithium orthophosphate (Li₃PO₄), lithium difluoro (oxalate) borate (LiDBoB), cyclic sulfone, polysulfide, lithium halide salts, and combinations thereof, so that the one or more additives impregnate the one or more ceramic coatings to form the coated separator.

13. The method of claim 12, wherein the contacting comprises:
immersing the precursor separator in a solution comprising the one or more additives for a period greater than or equal to about 1 minute to less than or equal to about 5 hours.

14. The method of claim 13, wherein the solution comprises:
a solvent having a first wettability with the one or more ceramic coatings and a second wettability with the microporous polymeric separator, wherein the first wettability is greater than the second wettability.

15. The method of claim 13, wherein the method further comprises at least one of:
preparing the solution;
coating the one or more surfaces of the microporous polymeric separator with the one or more ceramic coatings; and
drying the one or more ceramic coatings after contacting the solution.

16. The method of claim 16, wherein the drying comprises a vacuum drying process having a temperature greater than or equal to about 50° C. to less than or equal to about 130° C. and a period greater than or equal to about 1 hour to less than or equal to about 24 hours.

17. The method of claim 12, wherein the contacting comprises:
spraying an aerosol spray comprising the one or more additives onto the one or more ceramic coatings, wherein the aerosol spray comprises a solvent having a first wettability with the one or more ceramic coating and a second wettability with the microporous polymeric separator, the first wettability being greater than the second wettability, and the aerosol spray having a viscosity less than or equal to about 1,000 cp at room temperature.

18. The method of claim 17, wherein the method further comprises at least one of:
preparing the aerosol spray; and
drying the one or more ceramic coatings after contacting the aerosol spray.

19. The method of claim 18, wherein the drying comprises a vacuum drying process having a temperature greater than or equal to about 50° C. to less than or equal to about 130° C. and a period of greater than or equal to about 1 hour to less than or equal to about 24 hours.

20. The method of claim 12, wherein the one or more ceramic coatings each comprises a ceramic material independently selected from the group consisting of: lithiated zeolite, zeolite, aerogel, silica, alumina, titania, metal-organic frameworks (MOFs), and combinations thereof.
